(19) United States
(12) Patent Application Publication
(10) Pub. No.: US 2024/0429991 A1
(43) Pub. Date: Dec. 26, 2024

(54) DYNAMIC PANEL SWITCHING UNDER UNIFIED TCI FRAMEWORK

(71) Applicant: QUALCOMM Incorporated, San Diego, CA (US)

(72) Inventors: Fang Yuan, Beijing (CN); Yan Zhou, San Diego, CA (US); Wooseok Nam, San Diego, CA (US); Tao Luo, San Diego, CA (US)

(21) Appl. No.: 18/262,776

(22) PCT Filed: Mar. 22, 2021
(86) PCT No.: PCT/CN2021/081998

§ 371 Date: Jul. 25, 2023

(51) Int. Cl. H04B 7/06; H04B 7/08; H04L 5/00

(52) U.S. Cl. CPC H04B 7/0691; H04B 7/0874; H04L 5/0023

(57) ABSTRACT

Devices and methods for wireless communication between a scheduled entity having a plurality of antenna elements operable as multiple antenna and a scheduling entity include signaling transmission configuration information (TCI) to a scheduled entity to define unified TCI states that indicate beam directions of multiple corresponding beams, signaling a unified TCI state to be used for an upcoming communication for the scheduled entity using two or more beams as indicated by the unified TCI state.

### INTRODUCTION

In wireless communication, it can be useful for a wireless device to communicate using multiple antennas for a variety of reasons, such as to improve a signal-to-noise ratio, or to improve performance when communicating over disparate frequency ranges. MIMO (multiple-input multiple-output) technology is one application where multiple antenna elements are used to enhance system performance in so-called multipath reception environments. So-called “massive MIMO” technologies also enable the use of multiple transmission/reception point (MTRP) technologies in which a user device may communicate with multiple base stations or other transmission-reception points (TRPs). MTRP and other technologies may use directional transmission and reception techniques for improved performance. These and other technologies may require user equipment and other devices to employ two or more directional antennas.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In various aspects this disclosure proves for wireless communication procedures by which a base station (BS) may signal, to a user equipment device (UE) capable of communication using multiple antenna panels, necessary configuration information and scheduling information for simultaneous communication over multiple directional beams using multiple antenna panels. In some aspects, a single transport block or other grouping of information may be sent or received using multiple panels.

Some aspects of the disclosure provide a wireless communication device operable as a UE. The device includes a processor, a transceiver coupled to the processor, a plurality of antenna elements coupled to the transceiver, and memory coupled to the processor. The antenna elements configured to enable a single-panel configuration, and to enable a multi-panel configuration. The processor and the memory are configured to cause the wireless communication device to receive, via the transceiver, a first control element that defines one or more transmission configuration indication (TCI) states usable by the wireless communication device; receive, via the transceiver, a second control element configured to indicate a unified transmission configuration indication (TCI) state indicating TCI states assigned for use in the multi-panel configuration; receive, via the transceiver, a grant of resources for wireless communication; receive, via the transceiver, a third control element enabling use of the multi-panel configuration; and communicate over the granted resources utilizing the single-panel configuration or the multi-panel configuration according to the third control element.

Some aspects of the disclosure provide a method of wireless communication operable as a BS. The device includes a processor, a transceiver coupled to the processor, a plurality of antenna elements coupled to the transceiver, and memory coupled to the processor. The processor and the memory are configured to transmit, via the transceiver, a first control element that defines transmission configuration indication (TCI) states usable by a scheduled device; transmit, via the transceiver, a grant of resources for wireless communication; transmit, via the transceiver, a second control element configured to indicate a unified transmission configuration indication (TCI) state; transmit, via the transceiver, a third control element configured to cause the scheduled device to adopt the multi-panel configuration; and communicate with the scheduled device over the granted resources according one or more directional beams defined by a multi-panel configuration. The unified TCI state indicates TCI states assigned for use by the scheduled device in the multi-panel configuration.

Some aspects of the disclosure provide a method of wireless communication operable by a scheduled device having a plurality of antenna elements. The method includes receiving a first control element that defines one or more transmission configuration indication (TCI) states usable by the scheduled device; receiving a second control element configured to indicate a unified transmission configuration indication (TCI) state indicating TCI states assigned for use by the scheduled entity in a multi-panel configuration of the plurality of antenna elements; receiving a grant of resources for wireless communication; receiving a third control element enabling use of the multi-panel configuration; and communicating over the granted resources utilizing a single-panel configuration of the plurality of antenna elements or the multi-panel configuration of the plurality of antenna elements according to the third control element.

Some aspects of the disclosure provide a method of wireless communication operable by a scheduling device. The method includes transmitting a first control element that defines transmission configuration indication (TCI) states usable by a scheduled device; transmitting a grant of resources for wireless communication; transmitting a second control element configured to indicate a unified transmission configuration indication (TCI) state indicating TCI states assigned for use in a multi-panel configuration; transmitting a third control element configured to cause the scheduled device to adopt the multi-panel configuration; and communicating with the scheduled device over the granted resources according one or more directional beams defined by the multi-panel configuration.

These and other aspects of the technology discussed herein will become more fully understood upon a review of the detailed description, which follows. Other aspects, features, and embodiments will become apparent to those of ordinary skill in the art, upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication according to some aspects.

FIG. 4 is a schematic illustration of an organization of wireless resources in an air interface utilizing orthogonal frequency divisional multiplexing (OFDM) according to some aspects.

FIG. 5A-B illustrates two sequences of data communications according to some aspects.

FIG. 6 is a block diagram conceptually illustrating an example of a hardware implementation for a scheduling entity according to some aspects.

FIG. 7 is a block diagram conceptually illustrating an example of a hardware implementation for a scheduled entity according to some aspects.

FIG. 8 is a flow chart illustrating an exemplary process for scheduling multi-panel communications in a scheduling device according to some aspects.

FIG. 9 is a flow chart illustrating an exemplary process for configuring multi-panel communications in a scheduled device according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

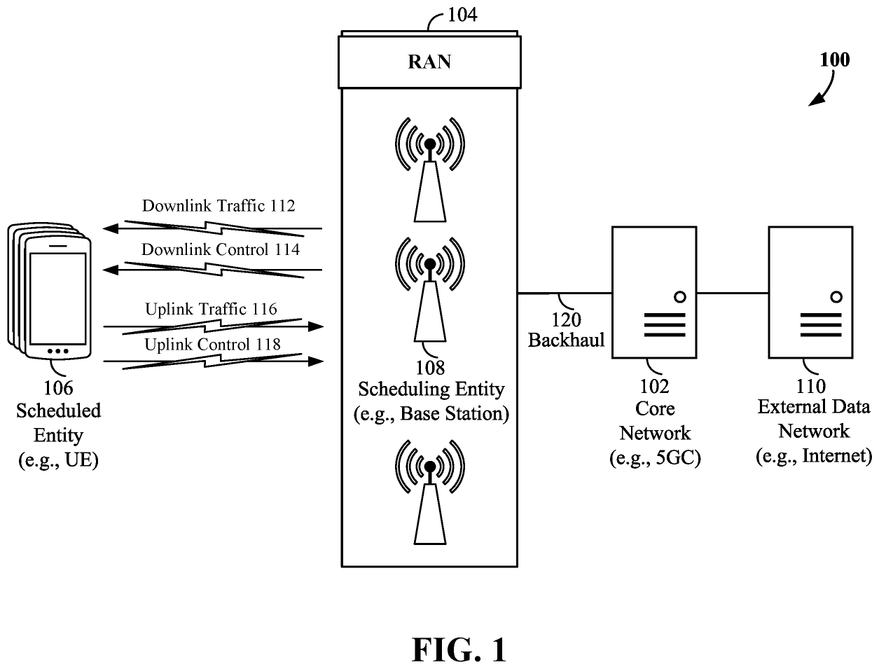

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains; a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a base station as a base transceiver station (BTS), a radio base station, a radio transceiver, a transceiver function, a basic service set (BSS), an extended service set (ESS), an access point (AP), a Node B (NB), an eNode B (eNB), agNode B (gNB), or some other suitable terminology.

The radio access network 104 supports wireless communication for multiple mobile apparatuses. Those skilled in the art may refer to a mobile apparatus as user equipment (UE) in 3GPP standards, but may also be refer to a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

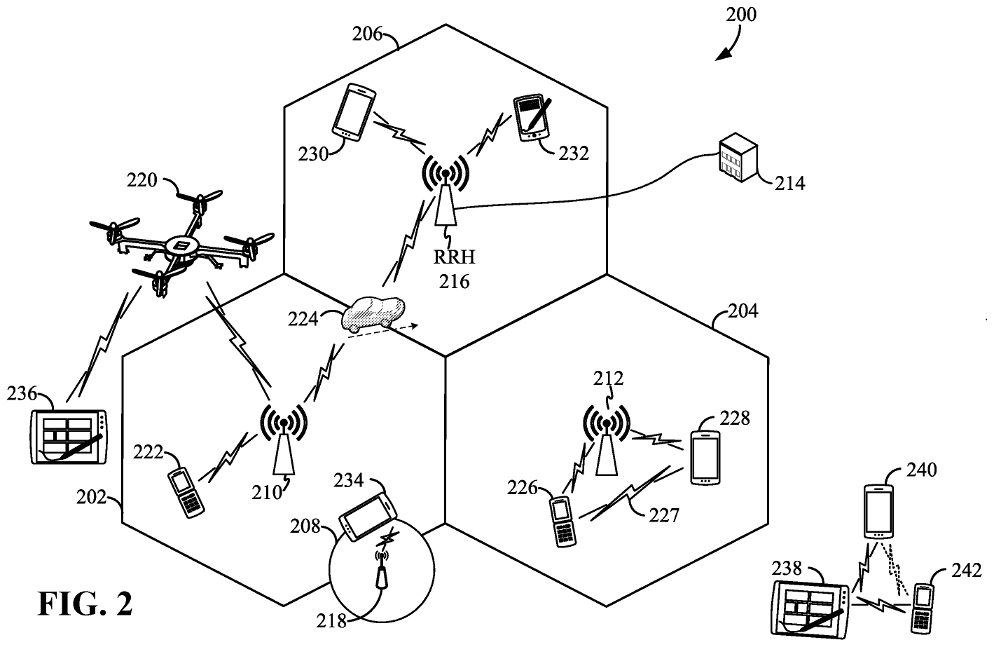

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a mobile base station (e.g., a quadcopter 220 or other drone which may be configured to function as a base station). That is, in some examples, a cell may not necessarily be stationary, and the geographic area of the cell may move according to the location of the quadcopter 220 (e.g., the quadcopter or drone pictured).

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with the quadcopter 220 acting as a mobile base station. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the UE 238 operating as a scheduling entity. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the RAN 200, the ability for a UE to communicate while moving, independent of its location, is referred to as mobility. An access and mobility management function (AMF, not illustrated, part of the core network 102 in FIG. 1) may generally set up, maintain, and release the various physical channels between the UE and the radio access network. The AMF may further include a security context management function (SCMF) that manages the security context for both the control plane and the user plane functionality, and a security anchor function (SEAF) that performs authentication.

The air interface in the RAN 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time utilizing a given resource. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

In order for transmissions over the radio access network 200 to obtain a low block error rate (BLER) while still achieving very high data rates, a transmitter may use channel coding. That is, wireless communication may generally utilize a suitable error correcting block code. In a typical block code, a transmitter splits up an information message or sequence into code blocks (CBs), and an encoder (e.g., a CODEC) at the transmitting device then mathematically adds redundancy to the information message. Exploitation of this redundancy in the encoded information message can improve the reliability of the message, enabling correction for bit errors that may occur due to the noise.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a base station may multiplex DL transmissions to UEs utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

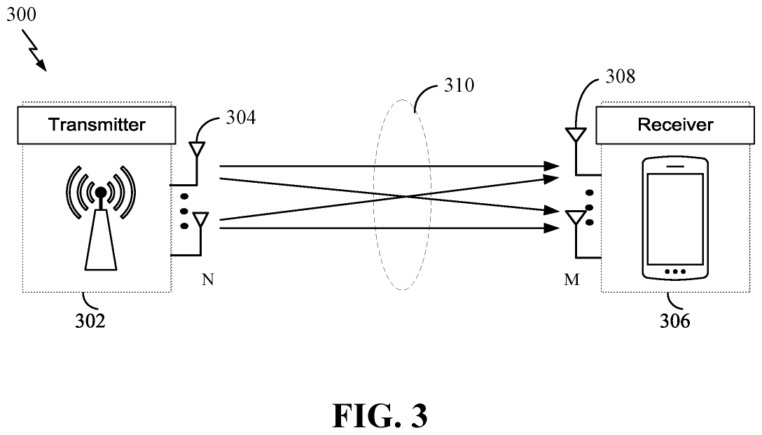

In some aspects of the disclosure, the scheduling entity and/or scheduled entity may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity. Directional antennas (i.e., antennas having anisotropic radiation patterns with directional gain) used for 5G communication are frequently electrically-steerable planar antennas such as planar arrays of antenna elements operated as phased arrays. Thus, individual antennas may be referred to antenna panels. The distinction between one antenna panel and another may be physical or virtual; that is, a device may have multiple physically separate antennas or a device may dynamically select subsets of antenna elements from a pool of antenna elements to operate as multiple virtual antenna panels enabling simultaneous communication over multiple

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront (i.e., a “beam”). In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 302 may send multiple data streams to a single receiver. In this way, a MIMO system takes advantage of capacity gains and/or increased data rates associated with using multiple antennas in rich scattering environments where channel variations can be tracked. Here, the receiver 306 may track these channel variations and provide corresponding feedback to the transmitter 302. In the simplest case, as shown in FIG. 3, a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. The receiver 306 may then reconstruct the data streams using the received signals from each receive antenna 308.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency, and reducing the required transmission energy. This is achieved by a transmitter 302 spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. A receiver (e.g., receiver 306) may transmit feedback including a quantized version of the channel so that the transmitter 302 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit or receive antennas 304 or 308, whichever is lower. In addition, the channel conditions at the receiver 306, as well as other considerations, such as the available resources at the transmitter 302, may also affect the transmission rank. For example, a base station in a RAN (e.g., transmitter 302) may assign a rank (and therefore, a number of data streams) for a DL transmission to a particular UE (e.g., receiver 306) based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions. The base station may use the RI along with resource information (e.g., the available resources and amount of data to be scheduled for the UE) to assign a DL transmission rank to the UE.

The transmitter 302 determines the precoding of the transmitted data stream or streams based, e.g., on known channel state information of the channel on which the transmitter 302 transmits the data stream(s). For example, the transmitter 302 may transmit one or more suitable reference signals (e.g., a channel state information reference signal, or CSI-RS) that the receiver 306 may measure. The receiver 306 may then report measured channel quality information (CQI) back to the transmitter 302. This CQI generally reports the current communication channel quality, and in some examples, a requested transport block size (TBS) for future transmissions to the receiver. In some examples, the receiver 306 may further report a precoding matrix indicator (PMI) to the transmitter 302. This PMI generally reports the receiver's 306 preferred precoding matrix for the transmitter 302 to use, and may be indexed to a predefined codebook. The transmitter 302 may then utilize this CQI/PMI to determine a suitable precoding matrix for transmissions to the receiver 306.

In Time Division Duplex (TDD) systems, the UL and DL may be reciprocal, in that each uses different time slots of the same frequency bandwidth. Therefore, in TDD systems, a transmitter 302 may assign a rank for DL MIMO transmissions based on an UL SINR measurement (e.g., based on a sounding reference signal (SRS) or other pilot signal transmitted from the receiver 306). An SRS may be transmitted by a UE using resources indicated by an SRS resource indication (SRI) that indicates to a UE antenna ports (as described below) and/or an uplink transmission beam to use for the SRS. Based on the assigned rank, the transmitter 302 may then transmit a channel state information reference signal (CSI-RS) with separate sequences for each layer to provide for multi-layer channel estimation. From the CSI-RS, the receiver 306 may measure the channel quality across layers and resource blocks. The receiver 306 may then transmit a CSI report (including, e.g., CQI, RI, and PMI) to the transmitter 302 for use in updating the rank and assigning resources for future DL transmissions.

When a transmitter 302 is configured for MIMO, the number of layers, or the rank of a transmission, corresponds to a number of antenna ports. Here, each antenna port may be defined such that the channel over which a symbol on the antenna port is conveyed can be inferred from the channel over which another symbol on the same antenna port is conveyed. For example, an antenna port may refer to a channel model, as defined by a reference signal transmitted over the channel using that antenna port. Each antenna port is mapped onto a set of antennas (e.g., a single dipole or an array of dipoles).

Two antenna ports are said to be quasi-colocated if properties of the channel over which a symbol on one antenna port is conveyed can be inferred from the channel over which a symbol on the other antenna port is conveyed. Thus, two antenna ports that are QCL are correlated with one another. A UE may utilize quasi-colocation (QCL) information to support beam-level mobility, for estimating frequency and time offsets due to Doppler shift and delay, etc.

In certain systems, such as NR (e.g., new radio or 5G) systems, data associated with a codeword is mapped to one or more demodulation reference signal (DM-RS) ports. DM-RS ports may be quasi collocated. Quasi-collocated DM-RS ports share a set of quasi collocation (QCL) parameters.

The set of parameters can be signaled by higher layer signaling, such as radio resource control (RRC) signaling. For example, the set of parameters can be signaled as a QCL-type. The QCL-type may be associated with a combination (e.g., set) of QCL relationships. In some examples, a QCL-TypeA indicates the DM-RS ports are QCL with respect to Doppler shift, Doppler spread, average delay, and delay spread; QCL-TypeB indicates the DM-RS ports are QCL with respect to Doppler shift, and Doppler spread; QCL-TypeC indicates the DM-RS are QCL with respect to average delay and Doppler shift; and QCL-TypeD indicates the DM-RS ports are QCL with respect to Spatial Rx parameter. Different groups of DM-RS ports can share different sets of QCL relationships.

While some examples below may refer to multi-TRP transmissions involving multiple TRPs, they may also apply to “multi-panel” transmissions involving multiple antenna panels of one TRP. As described above, a joint transmission may involve multiple sets of resources that may at least partially overlap or may be disjoint. Each set of resources may be associated with (allocated to) a different TRP (or different panel of a multi-panel TRP). As described herein, transmission on each set of resources may have its own associated transmission parameters (e.g., different modulation order and/or number of layers) and/or Transmission Configuration Indicator states. TCI states are generally dynamically sent over in a DCI message, and include parameters relating to resources for reference signals (e.g., a CSI-RS or an SS block) and quasi co-location (QCL) relationships between those RSs and the DM-RS ports of a given PDSCH/PDCCH. For example, TCI states can instruct a UE to determine beamforming settings for an upcoming communication (e.g., a PDSCH, PUSCH, PUCCH, etc.) based on reference signals it has already received, which are sufficient to identify a directional beam when combined with information provided in the form of a TCI state, as described below. QCL relationships specify types of similarity between two signals. For instance, a TypeA relationship indicates that the signals have similar Doppler shifts, Doppler spreads, average delays, and average delay spreads. A Type B relationship indicates that the signals have similar Doppler shifts and Doppler spreads but not necessarily average delays and average delay spreads. A Type C relationship indicates that the signals have similar Doppler shifts and average delays. A Type D relationship indicates that the signals have similar beamforming characteristics.

A UE may be RRC configured with a list of up to M candidate TCI states at least for the purposes of QCL indication. A MAC control element (MAC CE) may be used to select up to 2N TCI states out of M for PDSCH QCL indication, such that N bits in DCI can dynamically indicate the TCI state for the PDSCH transmission (e.g. if N=3, 2N=8). Each TCI state consists of one RS set for different QCL types (DL RS:SSB and AP/P/SP-CSI-RS/TRS).

Each tracking reference signal (TRS) can be used as a reference RS for power delay profile (PDP) calculation (TypeA/C) when configured in a TCI state, which will be used for channel estimation of DM-RS. A system may also support an extended QCL indication of DM-RS for PDSCH via DCI signaling for multi-TRP transmission, where each TCI state can refer to one or two RS sets, which indicates a QCL relationship for one or two DM-RS port group(s), respectively.

From the TRP perspective, the QCL relationships may be determined as follows. First, each TRP may send at least one RS (e.g., SSB and AP/P/SP-CSI-RS/TRS) that is QCLed with a DM-RS corresponding to transmission from that TRP. Second, all TRPs (both if only two) jointly determine the TCI state (for the case of one DCI) in the DCI field. In this case, this TCI state refers to both RS sets (from TRP1 and from TRP2) and this TCI state indicates the QCL relationships.

The TCI state may be signaled via a TCI field in DCI that indicates QCL relationship. The actual QCL relationships may be derived at the UE side based on the RS associated with the QCL relationship indicated in the TCI field. In some cases, the TCI field of the DCI may include multiple bits (e.g., 3 bits) with some values used to indicate multiple TCI states. For example, one code point could indicate TCI state 1,while a second code point indicates TCI states 2 and 3. In case multiple TCI states are indicated, one may apply to one disjoint set of RBs, while the other applies to a second disjoint set of RBs. Each TCI state may be associated with a different TRP or a different antenna panel in the case of a multi-panel TRP.

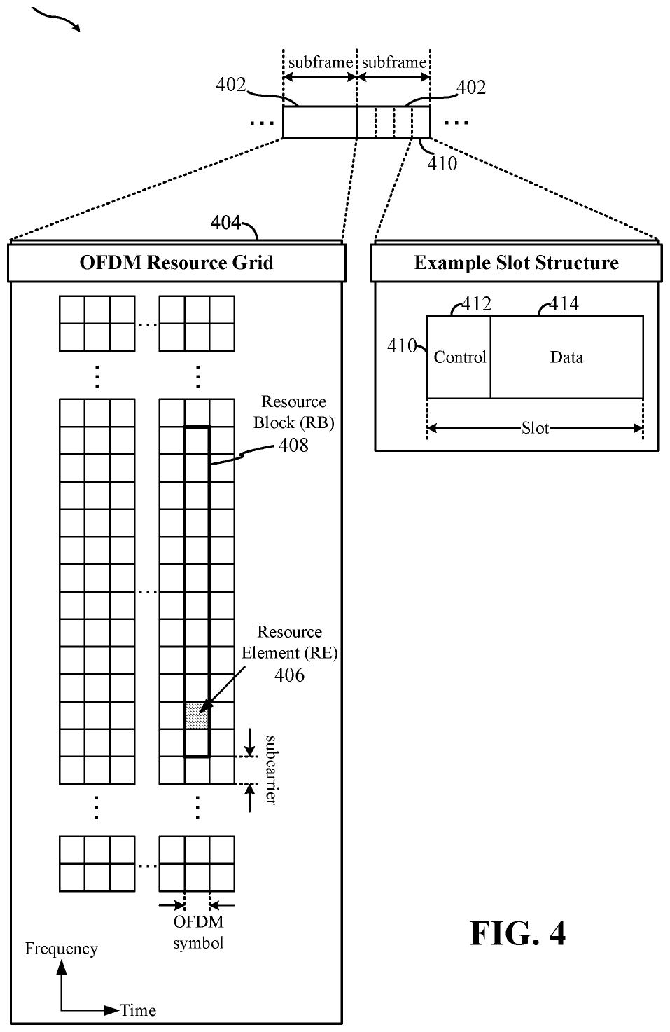

FIG. 4 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). A given carrier may include one set of frames in the UL, and another set of frames in the DL. FIG. 4 illustrates an expanded view of an exemplary DL subframe 402, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. The present disclosure assumes, by way of example, that a single RB such as the RB 408 corresponds to a single direction of communication (either transmission or reception for a given device).

A UE generally utilizes only a subset of the resource grid 404. An RB may be the smallest unit of resources that a scheduler can allocate to a UE. Thus, the more RBs scheduled for a UE, and the higher the modulation scheme chosen for the air interface, the higher the data rate for the UE.

In this illustration, the RB 408 occupies less than the entire bandwidth of the subframe 402, with some subcarriers illustrated above and below the RB 408. In a given implementation, the subframe 402 may have a bandwidth corresponding to any number of one or more RBs 408. Further, the RB 408 is shown occupying less than the entire duration of the subframe 402, although this is merely one possible example.

Each subframe 402 may consist of one or multiple adjacent slots. In FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A base station may in some cases transmit these mini-slots occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., the scheduling entity 108) may allocate one or more REs 406 (e.g., within a control region 412) to carry one or more DL control channels. These DL control channels include DL control information 114 (DCI) that generally carries information originating from higher layers, such as a physical broadcast channel (PBCH), a physical downlink control channel (PDCCH), etc., to one or more scheduled entities 106. In addition, the transmitting device may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The PDCCH may carry downlink control information (DCI) for one or more UEs in a cell. This can include, but is not limited to, power control commands, a redundancy version (RV), scheduling information (e.g., as a time-domain resource allocation (TDRA) that indicates time-slots allocated to a particular communication and/or a frequency-domain resource allocation (FDRA) that indicates frequency ranges allocated for the communication), a grant, an assignment of REs for DL and UL transmissions, an SRS resource indicator (SRI) indicating time-frequency resources to be used for SRS transmission, a dedicated multi-panel selection indicator, and/or any other suitable control information.

In some examples, a network may provide a transmission configuration indicator (TCI) to a UE. A TCI is a configuration information element (IE) that provides a UE with a set of TCI state parameters. These TCI state parameters may provide for one or more TCI states for a particular channel such as a PDSCH, PUSCH, PUCCH, and others. Here, each TCI state may indicate one or more QCL relationships. Each QCL relationship indicates a QCL type, and a RS (e.g., SSB, CSI-RS, TRS, etc.) that is QCL with the signal in question having that QCL type. A network may provide TCI state parameters utilizing any suitable signaling, including, but not limited to a MAC CE and/or a DCI. In some examples, other signaling layers such as radio resource control (RRC) signaling may be used, as a further non-limiting example.

A network may further transmit various suitable configuration message(s) that include multiple TCI states. In some examples, the network may provide these TCI state indications together. For example, a scheduling entity may utilize an RRC message, a MAC CE, a DCI, and/or any other suitable control signaling to provide a configuration message that includes multiple TCI states to a UE. The network may also provide the UE with an indication that the configuration message includes multiple TCI states. This indication may, but need not necessarily, be included in the same configuration message as the one including the multiple TCI states.

In some examples, a network may further identify what is referred to herein as a main TCI. That is, although a network may provide multiple TCIs to a UE, the network may identify one or more of those TCIs as a main TCI. For example, a network may include a 1-bit information element (IE) in a MAC CE/DCI to indicate whether the corresponding message provides a plurality of TCI states. In an event where multiple TCI states are provided, a UE may identify a subset (e.g., a predetermined subset known to the network) of the TCI states (e.g., the first TCI state received) as a main TCI state. In another example, rather than the 1-bit IE described above, a network may include one or more n-bit IE(s) to identify one or more TCI states as main TCI states. For example, each indicated TCI state may be associated with a suitable n-bit IE that indicates whether the corresponding TCI state is a main TCI state. In another example, such an n-bit IE may be configured with an index value, representing a corresponding indexed TCI state from among the multiple TCI states. Those of ordinary skill in the art will recognize that the above examples are only provided for the purpose of explanation, and that many other configurations of n-bit IE(s) may suitably identify a subset of one or more TCI states as main TCI states. A scheduling entity may utilize a MAC CE, a DCI, and/or any other suitable control signaling to transmit an indication to a UE of a change in TCI to be used. In some examples, the scheduling entity may provide such a SFN scheme change indication in the same message that carries the multiple TCI states, described above

Accordingly, a UE may receive and utilize a plurality of TCI states. A UE may detect (e.g., receive, demodulate, process, characterize, etc.) a data transmission (e.g., PDSCH) based only on the main TCI state(s), and not based on other TCI state(s) that are not identified as a main TCI. And furthermore, a UE may measure and report a channel state, a Doppler shift, and/or any other suitable channel parameter(s) based on each one of the multiple TCI states, and not only the main TCI state(s). That is, a UE may reduce its processing load by detecting a data transmission based only on a subset of received TCI states, rather than detecting the data transmission based on the full set of received TCI states.

As noted above, the QCL relationships may be indicated via one or more TCI states. The UE may thus determine the QCL relationships based on the TCI state and the frequency resource assignment (including distinguishing RB set 1 and RB set2 as described herein), using the corresponding RS for the corresponding RB set.

In a first case, a single PDCCH may be sent to signal the relevant QCL relationships. The single PDCCH could come from either one of the TRPs (or both). In another case, two separate PDCCHs may be sent, each signaling the relevant QCL relationships for each of TRPs (or sets of RBs). Both PDCCHs might come from the corresponding TRPs, or each PDCCH could come separately from both TRPs. The PDCCH may also carry the frequency domain resource allocation (FDRA). There are various types of frequency domain resource allocation types and the type indicates how the RBs assigned for PDSCH or PUSCH are signaled. For example, resource allocation (RA) type 0 is resource block group based (RBG)-based. An RBG is a group of RBs. If a total number of RBGs is N_RBG in a BWP, this field is a N_RBG bitmap indicating the scheduled RBGs out of all N_RBG RBGs (e.g., as a bitmap).

A scheduling entity may send transmit power configuration (TPC) commands to a UE that instruct the UE to increase or decrease the power used for uplink communications (e.g., PUSCH transmissions). TPC commands may be carried as one or more bits in a DCI. TPC commands may be absolute or cumulative. For instance, in one example, two bits of information indicate a degree to which the UE should adjust its transmit power for a PUSCH. The values {‘00’, ‘01’, ‘10’, ‘11’} may correspond, respectively, to a 1 dB power reduction, no power change, a 1 dB power increase, and a 3 dB power increase. In the cumulative mode, a subsequent TPC will result in the UE further adjusting the power by −1, 0, +1, or +3 dB, whereas in the absolute mode, the UE will adjust the power to conform to values specified by the latest TPC applicable to a PUSCH (or other transmission).

A scheduling entity can further use DCI to communicate information indicative of a sorted list of beams, such as DCI intended for a group of scheduled entities (e.g., group common DCI that includes sorted lists applicable to all multicast sessions that a member of the group is interested in accessing), and/or DCI directed to individual scheduled entities (e.g., that includes sorted lists for only multicast sessions that the scheduled entity is interested in accessing). Such an example may be well suited to scheduled entities that can be expected to move relatively quickly (e.g., UEs associated with vehicles, UEs carried by a person, etc.). A scheduling entity can transmit a DCI that grants multicast data transfer, in which the transmission configuration indication (TCI) field indicates a sorted list of beams. For example, the TCI field can include a list of quasi-co-location (QCL) information values that are each associated with one of the sorted lists of multicast beams for a particular multicast session.

A scheduling entity can transmit information indicative of a sorted list of beams (e.g., an RRC message, a MAC CE, DCI, etc.) using any suitable communication interface, such as a transceiver and any suitable communication network (e.g., via a RAN, such as RAN 104 or RAN 200, using one or more DL slots, etc.). As described above, a scheduling entity can use beam sweeping techniques (e.g., if such information is being broadcast) and/or beamforming techniques (e.g., if such information is being transmitted for a particular scheduled entity) to transmit information indicative of a sorted list of beams. In some aspects, a scheduling entity can transmit information indicative of a sorted list of beams and/or any other suitable control information associated with the multicast session(s) on the physical downlink control channel (PDCCH). For example the scheduling entity can transmit information indicative of a sorted list of beams and/or any other suitable control information associated with the multicast session(s) on a PDCCH using a single radio resource on a common wide beam that may be received by multiple devices.

Referring once again to FIG. 4, in an UL transmission, a transmitting device (e.g., a scheduled entity 106) may utilize one or more REs 406 to carry one or more UL control channels, such as a physical uplink control channel (PUCCH), a physical random access channel (PRACH), etc. These UL control channels include UL control information 118 (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc. HARQ-ACK retransmissions can be sent using multiple redundancy versions, corresponding, e.g., to different portions of redundant information from an encoded message that the retransmission includes. DL control information may contain an indication of the redundancy version (RV). The RV may be indicated by two bits in a dedicated field within a DCI.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

In some examples, a physical layer may generally multiplex and map these physical channels described above to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

### Dynamic Panel Switching Using Unified TCI signaling

In current (e.g., release-16) 3GPP Specifications for 5G NR, to configure a UE to receive a PDSCH under certain conditions, a network may transmit one or more MAC CE/DCI messages to indicate multiple TCI states, each corresponding to one or multiple panels, for a PDSCH transmission. As discussed above, a TCI state generally informs a UE which reference signal is QCL with a DM-RS transmitted with the PDSCH/PDCCH. For example, in a single-panel example, only a single RS is QCL with an identified DM-RS. However, when a UE uses a multi-panel configuration to communication with multiple TRPs, each TRP may transmit a RS that is QCL with the DM-RS. Thus, when a network provides a UE with multiple TCI states (each of which may correspond to a directional beams aimed in the direction of a corresponding TRP of multiple TRPs), the UE can estimate the DM-RS, and detect the PDSCH/PDCCH, based on each one of the QCL reference signals as indicated by the respective TCI states. In this manner, a UE can improve its channel estimation performance in receiving a multi-panel PDSCH transmission.

In a subsequent (e.g., release-17) publication of 3GPP Specifications for 5G NR, new types of TCI states, referred to as unified TCI states, have been introduced. In general, a unified TCI state refers to a TCI state that applies to multiple channels in unison (e.g., jointly). Here, a channel may refer to an identified PDSCH (PUSCH) transmission occasion. Thus, such a unified TCI state may specify a common beam used for two or more downlink channels, two or more uplink channels, or one or more of each of an uplink channel and a downlink channel.

For certain applications, extending the multi-panel downlink reception capability of a UE to multi-panel uplink transmission would realize related technical advantages. Multi-panel transmission may provide higher throughput or may achieve higher reliability by exploiting multiple panels in transmission. However, current specifications do not provide for dynamic signaling and utilization of configurations for multi-panel uplink communications.

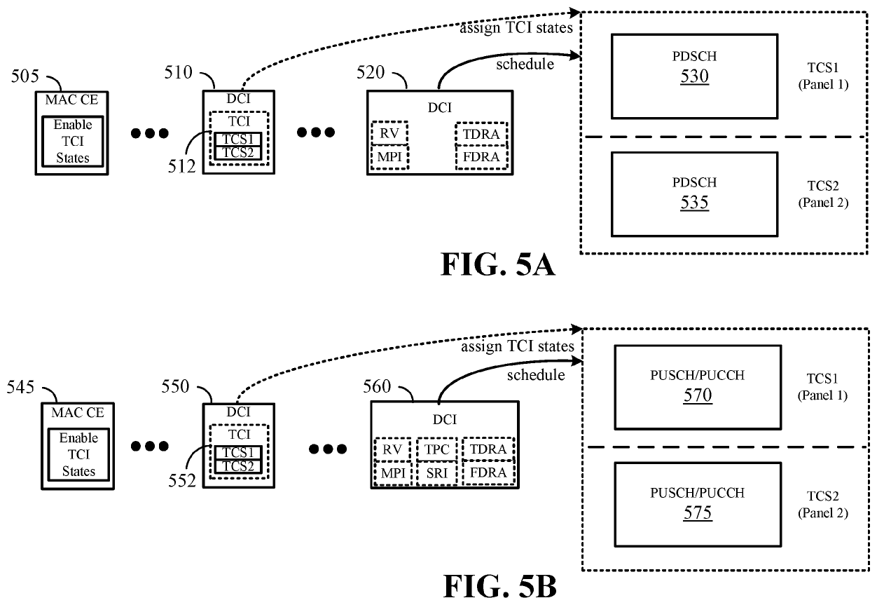

FIGS. 5A and 5B illustrate two example multi-panel communication sequences involving a BS (or RAN) and a UE according to some aspects disclosed herein. FIG. 5A illustrates simultaneous reception of a downlink communication 530 (i.e., a PDSCH communication) using a first panel configured according to a first transmission control state (i.e., a TCI state labeled TCS1) and reception of a downlink communication 535 (i.e., also a PDSCH communication) using a second panel configured according to a second transmission control state (i.e., a TCI state labeled TCS2). FIG. 5B illustrates simultaneous transmission of uplink communications 570, 575 (i.e., PUSCH or PUCCH communications) using a first panel configured according to a first transmission control state (i.e., a TCI state labeled TCS1) and using a second antenna panel configured according to a first transmission control state (i.e., a TCI state labeled TCS2). In various examples, a multi-panel configuration may be used to transmit or receive two independent communications (e.g., two distinct PDSCH communications, two distinct PUCCH transmissions, etc.), to transmit or receive portions of a single communication (e.g., portions of one PDSCH, or one PUSCH), or to redundantly transmit/receive the same communication to/from one or more receivers/transmitters.

In FIG. 5A, a device (e.g., a UE) receives a signal, represented by MAC CE 505, indicating that the device may enable use of channels with the two TCI states and then receives a DCI 510. In some examples, as illustrated by FIG. 5A, TCI states may be mapped to codepoints, which can indicate either a single TCI or multiple TCIs. As shown, the DCI 510 includes a unified TCI codepoint. A unified TCI codepoint is one that maps to multiple TCI states instead of one. The TCI 512) indicates two valid TCI states (TCS1, TCS2) associated with upcoming communications to be scheduled. The TCI 512 may use an index value or other information to indicate or identify particular TCI states having definitions stored in memory of the device. In some examples, the device receives these TCI state definitions from a scheduling entity via any suitable signaling technique including, but not limited to, RRC signaling.

The device further receives a DCI 520 that the schedules the communication associated with (or indicated in) the DCI 510. The DCI 520 may also include information referring to the TCI 512 and/or the TCI states (TCS1, TCS2). The device may also be configured to expect additional signaling information to enable the communications scheduled by the DCI 520 to be processed according to the multi-panel arrangement identified by the TCI 512. As a non-limiting example, a multi-panel indication may be included as part of a redundancy version (RV) field of the DCI 520. Alternatively, a multi-panel indication may be included as part of resource allocation field of the DCI 520, such as a time-division resource allocation (TDRA) or a frequency-division resource allocation (FDRA) of the DCI. As another alternative, the DCI 520 may include a dedicated multi-panel indicator (MPI) field.

The sequence depicted in FIG. 5B is analogous to the sequence depicted in FIG. 5A, except that FIG. 5B depicts the specific case where the two communications are both uplink communications (570, 575) scheduled by the DCI 560. A multi-panel configuration including the two TCI states TCS1, TCS2 is specified and enabled using the MAC CE 545 (analogous to the MAC CE 505), the DCI 550, which carries the TCI 552 (analogous to the DCI 510 carrying the TCI 512), and the scheduling DCI 560 (analogous to the scheduling DCI 520). As in FIG. 5A, the device may also be configured to expect additional signaling information to enable the communications scheduled by the DCI 560 to be processed according to the multi-panel arrangement identified by the TCI 552. For instance, the DCI 560 may include an RV field, a TDRA or FDRA field, and/or a new dedicated MPI field not present in previous 3GPP standards. In the case of the DCI 560, which schedules uplink transmissions, other DCI fields that are specifically applicable to uplink transmissions may be used, including as non-limiting examples a transmission power control (TPC) field and/or an SRS resource indicator (a “sounding reference signal resource indicator” or SRI) field. For example, if a TPC field in the DCI 560 includes or indicates two transmission power control commands, the UE may infer that the scheduled uplink communication is a multi-panel transmission utilizing, e.g., two antenna panels, each corresponding to one of the TPCs. Similarly, if an SRI field in the DCI 560 indicates two sets of sounding reference signal resources (each allocated for a distinct SRS), the UE may infer that that scheduled uplink transmission is a multi-panel transmission utilizing, e.g., two antenna panels, each corresponding to one SRS. In some examples the DCIs 520, 560 may schedule a single transport block transmitted using two TCI states, as shown in FIGS. 5A and 5B.

It will be appreciated that, although examples herein may describe multi-panel communications utilizing two antenna panels, that such examples are not intended to limit embodiments herein to utilizing only one or two antenna panels and that embodiments may utilize any suitable number of antenna panels according to different applications. It will also be appreciated that, in some examples, one or more of the MAC CE 505/545 the DCI 510/550, or the DCIs 520/560 may be transmitting or received in different orders from the orders depicted or may not be required. For example, instead of being signaled by a DCI 510/550, the TCI 512/552 for the scheduled communications may be signaled using any acceptable signaling method, including, but not limited to, RRC signaling.

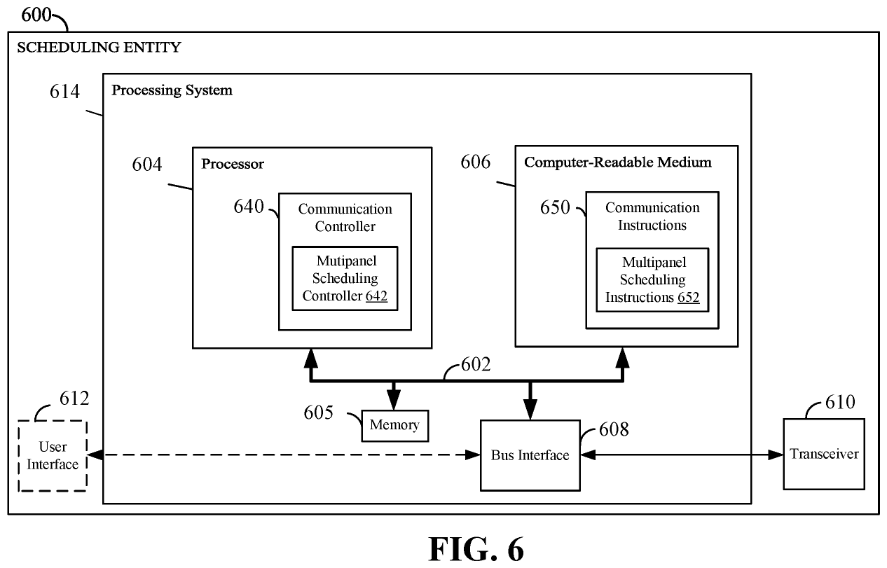

FIG. 6 is a block diagram illustrating an example of a hardware implementation for a scheduling entity 600 employing a processing system 614. For example, the scheduling entity 600 may be a user equipment (UE) as illustrated in any one or more of FIGS. 1, 2, and/or 3. In another example, the scheduling entity 600 may be a base station as illustrated in any one or more of FIGS. 1, 2, and/or 3.

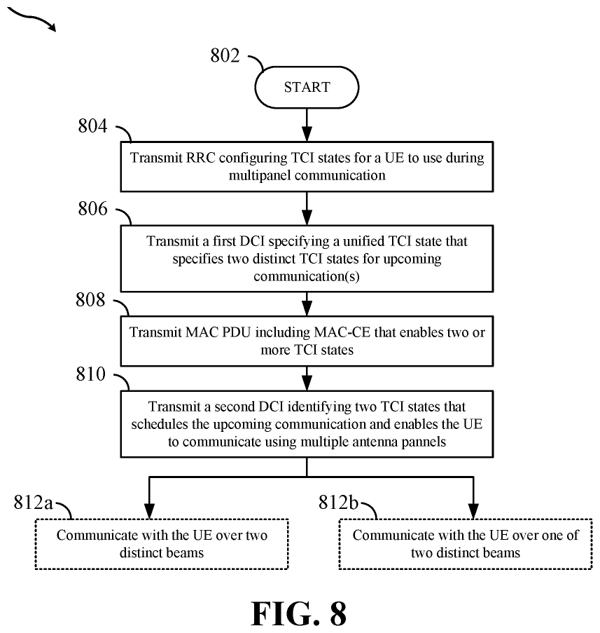

The scheduling entity 600 may include a processing system 614 having one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 600 may be configured to perform any one or more of the functions described herein. That is, the processor 604, as utilized in a scheduling entity 600, may be configured (e.g., in coordination with the memory 605) to implement any one or more of the processes and procedures described below and illustrated, e.g., in FIG. 8.

The processing system 614 may be implemented with a bus architecture, represented generally by the bus 602. The bus 602 may include any number of interconnecting buses and bridges depending on the specific application of the processing system 614 and the overall design constraints. The bus 602 communicatively couples together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a communication interface or means for communicating with various other apparatus over a transmission medium. Depending upon the nature of the apparatus, a user interface 612 (e.g., keypad, display, speaker, microphone, joystick) may also be provided. Of course, such a user interface 612 is optional, and some examples, such as a base station, may omit it.

In some aspects of the disclosure, the processor 604 may include a communication controller 640 and a multi-panel scheduling controller 642 (e.g., in coordination with the memory 605) for various functions, including, e.g., signaling multi-panel configuration information (e.g., the TCIs 512, 552 of FIG. 5 and scheduling instructions (e.g., DCI including scheduling grants such as the DCIs 520, 560 of FIG. 5) with UEs or other devices, and communicating with those devices accordingly. For example, the multi-panel scheduling controller 642 may be configured to implement one or more of the functions described below in relation to FIG. 8 including, e.g., blocks 804-810.

The processor 604 is responsible for managing the bus 602 and general processing, including the execution of software stored on the computer-readable medium 606. The software, when executed by the processor 604, causes the processing system 614 to perform the various functions described below for any particular apparatus. The processor 604 may also use the computer-readable medium 606 and the memory 605 for storing data that the processor 604 manipulates when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable medium 606 may store computer-executable code that includes communication instructions 650 (which include multi-panel scheduling instructions 652) that configure a scheduling entity 600 for various functions, including, e.g., signaling multi-panel configuration information e.g., the TCIs 512, 552 of FIG. 5 and scheduling instructions (e.g., DCI including scheduling grants such as the DCIs 520,560 of FIG. 5) with UEs or other devices, and communicating with those devices accordingly. For example, the multi-panel scheduling instructions 652 may be configured to cause a scheduling entity 600 to implement one or more of the functions described below in relation to FIG. 8, including, e.g., blocks 804-810.

In one configuration, an apparatus for wireless communication (e.g., the scheduling entity 600) includes means for transmitting control elements that indicate TCI to UE for multi-panel communication and means for scheduling such multi-panel communications. In one aspect, the aforementioned means may be the processor(s) 604 shown in FIG. 6 configured to perform the functions recited by the aforementioned means. In another aspect, the aforementioned means may be a circuit or any apparatus configured to perform the functions recited by the aforementioned means.

Any suitable control elements may be used in any combination. For instance, in the example of FIGS. 5A-B, the first control element is a set of bits in a MAC CE indicating TCI states that are enabled for communication between the BS and a UE; the second control element is a TCI such as the TCI 512 that indicates TCI states assigned for an upcoming communication; and the third control element is a multi-panel selection indicator (MPI) that the UE should adopt a multi-panel configuration for a scheduled communication, carried as one or more bits in a scheduling DCI 520/560. These bits may be transmitted in a field already defined according to previous 3GPP specifications, with one or more bits repurposed for use as the MPI. In other examples, previously defined fields may be expanded to include the MPI. In another example, a new MPI field may be defined and dedicated to carrying the MPI. Other signaling methods may also be used, including RRC signaling as a non-limiting example. In the above examples, the circuitry included in the processor 604 is merely provided as an example, and other means for carrying out the described functions may be included within various aspects of the present disclosure, including but not limited to the instructions stored in the computer-readable medium 606, or any other suitable apparatus or means described in any one of the FIGS. 1, 2, and/or 3, and utilizing, for example, the processes and/or algorithms described herein in relation to FIG. 8

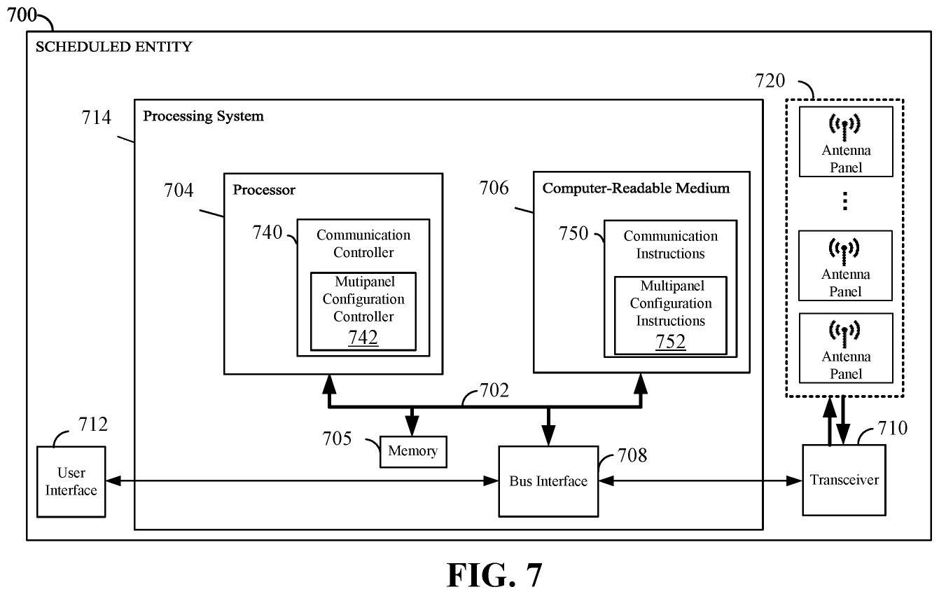

FIG. 7 is a conceptual diagram illustrating an example of a hardware implementation for an exemplary scheduled entity 700 employing a processing system 714. In accordance with various aspects of the disclosure, a processing system 714 may include an element, or any portion of an element, or any combination of elements having one or more processors 704. For example, the scheduled entity 700 may be a user equipment (UE) as illustrated in any one or more of FIGS. 1, 2, and/or 3.

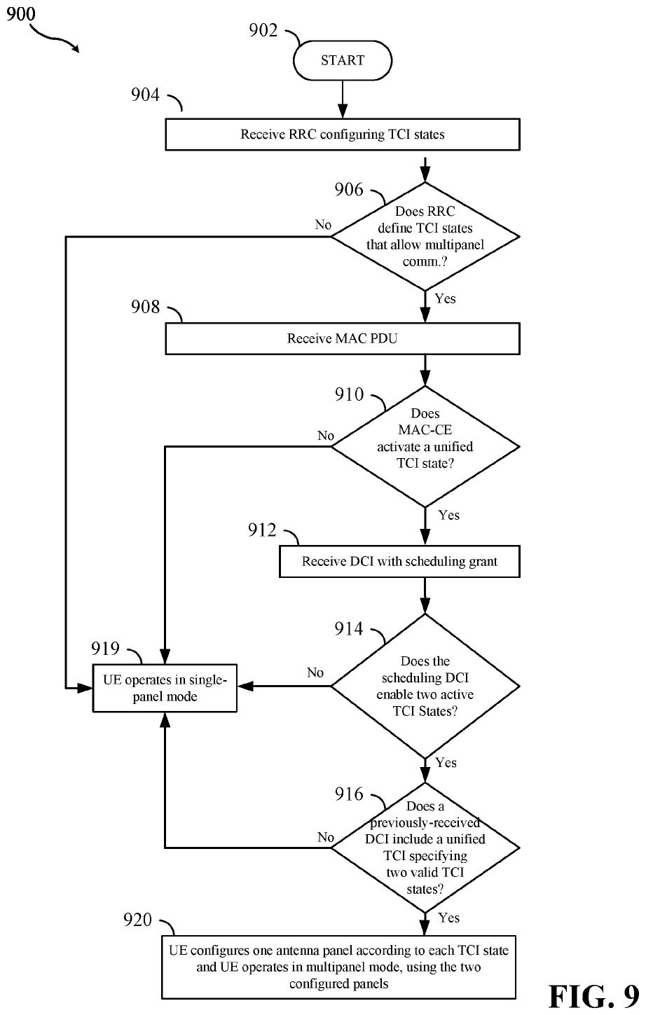

The processing system 714 may be substantially the same as the processing system 614 illustrated in FIG. 6, including a bus interface 708, a bus 702, memory 705, a processor 704, and a computer-readable medium 706. Furthermore, the scheduled entity 700 may include a user interface 712 and a transceiver 710 substantially similar to those described above in FIG. 7. That is, the processor 704, as utilized in a scheduled entity 700, may be configured (e.g., in coordination with the memory 705) to implement any one or more of the processes described below and illustrated, e.g., in FIG. 9.

The transceiver 710 is coupled to two or more antenna panels 720 that are usable for transmission and reception of wireless signals. Each antenna panel 720 may be an individual directional antenna that is either physically or electrically steerable (e.g., an electrically steerable phased array). In some examples, one or more antenna panels 720 may be “virtual antennas” formed by dynamically addressing individual receiver elements in a reconfigurable array and operating those receiver elements as a phased array having characteristics desired for a particular application or desired at a particular point in time.

In some aspects of the disclosure, the processor 704 may include a communication controller 740 including a multi-panel configuration controller 742 configured (e.g., in coordination with the memory 705) for various functions, including, for example, receiving multi-panel configuration information (e.g., the TCIs 512, 552 of FIG. 5 and scheduling instructions (e.g., DCI including scheduling grants such as the DCIs 520,560 of FIG. 5). For example, the communication controller 740 may be configured to implement one or more of the functions described below in relation to FIG. 9 including, e.g., blocks 904-920.

And further, the computer-readable storage medium 706 may store computer-executable code that includes communication instructions 850 that include multi-panel configuration instructions 752 that configure a scheduled entity 700 for various functions, including, for example, receiving multi-panel configuration information e.g., the TCIs 512, 552 of FIG. 5 and scheduling instructions (e.g., DCI including scheduling grants such as the DCIs 520,560 of FIG. 5). For example, the communication instructions 750 may be configured to cause a scheduled entity 700 to implement one or more of the functions described below in relation to FIG. 9, including, e.g., blocks 904-920.

In one configuration, an apparatus for wireless communication (e.g., the scheduled entity 700) includes means for receiving control elements that indicate TCI for multi-panel communication and means for configuring multiple antenna panels. In one aspect, the aforementioned means may be the processor(s) 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, and/or 3, and utilizing, for example, the processes and/or algorithms described herein in relation to FIG. 9

FIG. 8 is a flow chart illustrating an exemplary process 800 for a BS (or a RAN or other scheduling entity) to signal multi-panel configuration information in accordance with some aspects of the present disclosure. As described below, a particular implementation may omit some or all illustrated features and may not require some illustrated features to implement all embodiments. In some examples, the scheduling entity 600 illustrated in FIG. 6 may be configured to carry out the process 800. In some examples, any suitable apparatus or means for carrying out the functions or algorithm described below may carry out the process 800.

At block 802 the process begins and proceeds to block 804, where the BS transmits RRC information to a UE (or other scheduled entity) that configures TCI states usable by the UE for multi-panel communication. These TCI states define, e.g., QCL relationships that indicate beam directions to the UE based on the QCL relationships as applied to reference signals received by the UE during communication with the BS (and potentially other transmitters belonging to the same network). In some examples, the UE may be preconfigured to store the TCI states in memory (e.g., the memory 705) or to receive the TCI states via any other suitable signaling mechanism.

At block 806, the BS transmits a DCI that selects two (or more) TCI states for use in scheduling upcoming multi-panel communication involving the BS and the UE from the set of all (prospectively) usable TCI states configured at block 804. In some examples, these TCI states are specified according to a unified TCI format that signals two (or more) TCI states together. This BS may signal, in this DCI or otherwise (e.g., via RRC signaling), that the TCI states are associated with a particular future transmission opportunity or with a particular future time window.

At block 808, the BS transmits a MAC PDU that includes a MAC CE that explicitly indicates that the TCI states signaled at block 806 are enabled for use by the UE.

At block 810, the BS transmits a scheduling DCI containing a scheduling grant for an anticipated multi-panel communication. In some examples, the scheduling DCI further indicates that the scheduling grant allocates resources for one or more multi-panel communications. In some examples, the scheduling DCI includes one or more of the TCI states signaled by the earlier DCI transmitted at block 806. In some examples, the scheduling DCI includes one or more fields that may be used to explicitly or implicitly signal that the scheduled communications are multi-panel communications. For example, the scheduling DCI may include an RV field that includes an indication that the UE is to communicate using a multi-panel configuration. In some examples, a modified RV field includes an additional multi-panel indication that explicitly indicates that the scheduled communications are multi-panel communications. In some other examples, an RV field is configured as defined in release 16 of the 3GPP standards for NR and the UE infers from the redundancy value that the scheduled communications are multi-panel communications.

In some examples, The BS may indicate that the multi-panel configuration is to be used via a TDRA or FDRA field of the scheduling DCI. In some examples, the BS may indicate that the multi-panel configuration is to be used via a dedicated multi-panel indication (MPI) field of the scheduling DCI. In some examples, the BS may additionally or alternatively use fields that are specifically relevant to uplink communications scheduled by the scheduling DCI to indicate that the multi-panel configuration is to be used, such as a transmission power control (TPC) field and/or an SRS resource indicator (a “sounding reference signal resource indicator” or SRI) field as non-limiting examples. For example, a BS may signal that the scheduled uplink communication is a multi-panel transmission utilizing two antenna panels, each corresponding to one of the TPCs, by including two transmission power control commands in a TPC field of a scheduling DCI. Similarly, the BS may signal that that scheduled uplink transmission is a multi-panel transmission utilizing two antenna panels, each corresponding to one of the SRIs, by including two SRIs in the scheduling DCI.

The process continues to block 812a or 812b, depending upon the nature of the communications scheduled by the BS. It should be understood, that in some examples, the BS may proceed to block 812a for one or more transmission occasions and proceed to block 812b for or more other transmission occasions.

At block 812a, the BS communicates over two beams with a UE that has adopted the multi-panel configuration signaled by the BS. Each beam corresponds to one of the two antenna panels of the UE, and each panel is configured according to one of the TCI states signaled by the BS at block 806. In some instances, the BS may be responsible for scheduling communication between the UE and additional TRPs, in which case the BS proceeds to block 812b as appropriate, wherein the BS communicates with the UE over one of the two beams while the UE communicates over the other beam with one or more other TRPs.

In some examples, at appropriate times, a BS performing the process 800 may be responsible for signaling and/or scheduling the multi-panel communication between the UE and one or more other TRPs, in which case the BS omits blocks 812a and 812b.

FIG. 9 is a flow chart illustrating an exemplary process 800 for a UE to receive multi-panel configuration information and implement an appropriate multi-panel communication configuration in accordance with some aspects of the present disclosure. As described below, a particular implementation may omit some or all illustrated features and may not require some illustrated features to implement all embodiments. In some examples, the scheduled entity 700 illustrated in FIG. 7 may be configured to carry out the process 900. In some examples, any suitable apparatus or means for carrying out the functions or algorithm described below may carry out the process 900.

At block 902 the process begins and proceeds to block 904, where the UE receives RRC signals configuring prospective TCI states usable by the UE for multi-panel communication. In some examples, the UE may be preconfigured to store the TCI states in memory (e.g., the memory 705) or to receive the TCI states via any other suitable signaling mechanism.

At block 906, the UE determines whether the RRC signals (or other suitable signals defining TCI states for the UE) are compatible with multi-panel communication. If the RRC signals are not compatible with multi-panel communication, the UE proceeds to block 919 (i.e., the UE enters or remains in a single-panel configuration). If the RRC signals are compatible with multi-panel communication, the UE proceeds to block 908. In some examples, the UE may determine that the RRC signals or other signals defining TCI states are compatible with multi-panel communication by determining whether they are specified according to an appropriate unified TCI format in which a two or more TCI states are grouped together to form a single unified TCI state.

At block 908, the UE receives one or more MAC PDUs including MAC CE information (e.g., MAC CE 505 or MAC CE 545) and proceeds to block 910.

At block 910 the UE determines whether the MAC CE information signals that that a unified TCI state indicating two or more TCI states is activated for use by the UE. If not, the UE proceeds to block 919. Otherwise, the UE proceeds to block 912.

At block 912, the UE receives a scheduling DCI (e.g., DCI 520, or DCI 560) containing a scheduling grant.

At block 914, the UE determines whether the scheduling DCI received at block 912 enables two activated TCI states (i.e., states activated according to the MAC CE received at block 908). If the scheduling DCI enables two activated TCI states, the UE proceeds to block 920; otherwise the UE proceeds to block 919 (i.e., the UE enters or remains in a single-panel configuration).

At block 916, the UE determines whether a previously-received DCI (e.g., the DCI 510 or DCI 550) indicates a unified TCI state field specifying one or two valid TCI states (e.g., TCS1, TCS2 as shown in FIGS. 5A, 5B). If the previous DCI indicates in a unified TCI state field specifying two valid TCI states, the UE proceeds to block 916; otherwise, the UE proceeds to block 919 (i.e., the UE enters or remains in a single-panel configuration).

In some examples, the scheduling DCI received at block 912 includes one or more fields which may be used to explicitly or implicitly indicate that the scheduled communications are multi-panel communications. For example, in some examples, the scheduling DCI may include an RV field indicating that the UE is to communicate using a multi-panel configuration. In some examples, a modified RV field includes an additional multi-panel indication that explicitly indicates that the scheduled communications are multi-panel communications. In other examples, this RV field is configured as defined in release 16 of the 3GPP standards for NR and the UE infers from the redundancy value that the scheduled communications are multi-panel communications

In some examples, the scheduling DCI may indicate that the multi-panel configuration is to be used via a TDRA or FDRA allocation field. In some aspects, the BS may indicate that the multi-panel configuration is to be used via a dedicated multi-panel indication (MPI) field in the scheduling DCI. For example the MPI may be a single bit where a ‘0’ value indicates that a single panel communication is being scheduled and a ‘1’ value indicates that a multi-panel communication is being scheduled.

In some examples, the scheduling DCI may also use fields that are specifically relevant to uplink communications scheduled by the scheduling DCI to indicate that the multi-panel configuration is to be used. For example, if a TPC field includes two transmission power control commands, the scheduling DCI may signal that the scheduled uplink communication is a multi-panel transmission utilizing two antenna panels, each corresponding to one of the TPCs. Similarly, if an SRI field in the scheduling DCI indicates two sets of sounding reference signal resources (each allocated for a distinct SRS), the scheduling DCI may indicate that the scheduled uplink transmission is a multi-panel transmission utilizing two antenna panels, each corresponding to one set of SRS resources. In some examples, a modified TPC field or a modified SRS field is used which is expanded beyond previous standards-based definitions to include an additional explicit multi-panel configuration indication. In some examples, a modified FDRA field or a modified TDRA field is used which is expanded over previous standards-based definitions to include an additional explicit multi-panel configuration indication.

At block 920, the UE determines that the communication(s) scheduled by the scheduled DCI is a multi-panel communication and configures a transceiver (e.g., the transceiver 710) to configure one antenna panel (e.g., one of the antenna panels 720) corresponding to each TCI state such that the panel of the corresponding antenna has a directional pattern consistent with communication over a directional beam identified using that TCI state. In some examples, the UE is provided with discrete antenna panels which are electrically steerable (e.g., by combining signals from a plurality of antenna elements and applying appropriate amplitudes and phase shifts to the signals from each element to operate the antenna elements as a phased array). In some examples, the UE may dynamically select antenna elements from one or more “pools” of antenna elements and operate the selected antenna elements as a phased array using any suitable number and combination of elements.

### Further Examples Having a Variety of Features

Example 1: A method, apparatus, and non-transitory computer-readable medium for receiving a first control element that defines one or more transmission configuration indication (TCI) states usable by the wireless communication device; receiving a second control element configured to indicate a unified transmission configuration indication (TCI) state indicating TCI states assigned for use by the scheduled entity in a multi-panel configuration of the plurality of antenna elements; receiving a grant of resources for wireless communication; receiving a third control element enabling use of the multi-panel configuration; and communicating over the granted resources utilizing a single-panel configuration of the plurality of antenna elements or the multi-panel configuration of the plurality of antenna elements according to the third control element.

Example 2: A method, apparatus, and non-transitory computer-readable medium of Example 1, further including configuring a first antenna panel corresponding to a first subset of a plurality of antenna elements for directional communication along a first spatial direction indicated by the unified TCI state; configuring a second antenna panel corresponding to a second subset of the plurality of antenna elements for directional communication along a second spatial direction indicated by the unified TCI state.

Example 3: A method, apparatus, and non-transitory computer-readable medium of any of Examples 1 to 2, further including receiving one or more radio resource control (RRC) signals including the first control element; receiving first downlink control information (DCI) including at least a part of the second control element, the second control element indicating, to the wireless communication device, the first spatial direction, and the second spatial direction; and receiving second downlink control information (DCI) that includes the grant of resources for wireless communication and the third control element.

Example 4: A method, apparatus, and non-transitory computer-readable medium of any of Examples 1 to 3, further including obtaining the third control element from one or more of the following fields of the second DCI; a frequency division resource allocation (FDRA) field, a time division research allocation (TDRA) field, a redundancy version (RV) field, or a multi-panel indication field.

Example 5: A method, apparatus, and non-transitory computer-readable medium of any of Examples 1 to 3, wherein the communication that is scheduled by the second DCI is a physical uplink control channel (PUCCH) transmission or a physical uplink shared channel (PUSCH) transmission; and further including obtaining the third control element from one of the following fields of the second DCI; a field mapped at least two sounding reference signal resource indicators (SRIs), each SRI indicating resources for a corresponding sounding reference signal (SRS); or a field mapped with at least two transmit power commands (TPCs).

Example 6: A method, apparatus, and non-transitory computer-readable medium for transmitting a first control element that defines transmission configuration indication (TCI) states usable by a scheduled device; transmitting a grant of resources for wireless communication; transmitting a second control element configured to indicate a unified transmission configuration indication (TCI) state indicating TCI states assigned for use in a multi-panel configuration; transmitting a third control element configured to cause the scheduled device to adopt the multi-panel configuration; and communicating with the scheduled device over the granted resources according one or more directional beams defined by the multi-panel configuration.

Example 7: A method, apparatus, and non-transitory computer-readable medium of Example 6, further including transmitting one or more radio resource control (RRC) signals including the first control element; transmitting first downlink control information (DCI) including the second control element, the second control element indicating, for the scheduled device, the first spatial direction, and the second spatial direction; and transmitting second downlink control information (DCI) that schedules a communication over the granted resources, the second DCI including the third control element.

Example 8: A method, apparatus, and non-transitory computer-readable medium of either of Examples 6 to 7, further for including the third control element in one of the following fields of the second DCI: a frequency division resource allocation (FDRA) field, a time division research allocation (TDRA) field, a redundancy version (RV) field, or a multi-panel reception indication field.

Example 9: A method, apparatus, and non-transitory computer-readable medium of either of Examples 6 to 7, wherein the communication that is scheduled by the second DCI is a physical uplink control channel (PUCCH) transmission or a physical uplink shared channel (PUSCH) transmission to be transmitted to the scheduling device; and further for including the third control element in one of the following fields of the second DCI: a field mapped with multiple sounding reference signal resource indicators (SRIs), each SRI indicating resources for a corresponding sounding reference signal; or a field mapped with multiple transmit power commands (TPCs).

This disclosure presents several aspects of a wireless communication network with reference to an exemplary implementation. As those skilled in the art will readily appreciate, various aspects described throughout this disclosure may be extended to other telecommunication systems, network architectures, and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 702.11 (Wi-Fi), IEEE 702.16 (WiMAX), IEEE 702.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The present disclosure uses the term “coupled” to refer to a direct or indirect coupling between two objects. For example, if object A physically touches object B, and object B touches object C, then objects A and C may still be considered coupled to one another even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features, and/or functions illustrated in FIGS. 1-9 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-9 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The terms “may” and “can” as used in connection with aspects and features herein are equivalent and refer to elements which are present in certain embodiments but not necessarily others, or to describe actions that are performed by a particular device or component in one aspect that are capable of being performed by other devices or components in aspects.

What is claimed is:

1. A wireless communication device comprising:
a processor;
a transceiver coupled to the processor;
a plurality of antenna elements coupled to the transceiver, the antenna elements configured to enable a single-panel configuration, and to enable a multi-panel configuration; and
a memory coupled to the processor,
wherein the processor and the memory are configured to cause the wireless communication device to:
receive, via the transceiver, a first control element that defines one or more transmission configuration indication (TCI) states usable by the wireless communication device;
receive, via the transceiver, a second control element configured to indicate a unified transmission configuration indication (TCI) state indicating TCI states assigned for use in the multi-panel configuration;
receive, via the transceiver, a grant of resources for wireless communication;
receive, via the transceiver, a third control element enabling use of the multi-panel configuration; and
communicate over the granted resources utilizing the single-panel configuration or the multi-panel configuration according to the third control element.

2. The wireless communication device of claim 1, wherein the processor and the memory are further configured to cause the wireless communication device to:
configure a first antenna panel corresponding to a first subset of the plurality of antenna elements for directional communication along a first spatial direction indicated by the unified TCI state; and
configure a second antenna panel corresponding to a second subset of the plurality of antenna elements for directional communication along a second spatial direction indicated by the unified TCI state.

3. The wireless communication device of claim 2, wherein the processor and the memory are further configured to cause the wireless communication device to:
receive one or more radio resource control (RRC) signals including the first control element;
receive first downlink control information (DCI) including at least a part of the second control element, the second control element indicating, to the wireless communication device, the first spatial direction, and the second spatial direction; and
receive second downlink control information (DCI) that includes the grant of resources for wireless communication and the third control element.

4. The wireless communication device of claim 3, wherein the processor and the memory are further configured to cause the wireless communication device to determine the third control element using one or more of the following fields of the second DCI:
a frequency division resource allocation (FDRA) field,
a time division research allocation (TDRA) field,
a redundancy version (RV) field, or
a multi-panel indication field.

5. The wireless communication device of claim 3, wherein the communication that is scheduled by the second DCI is a physical uplink control channel (PUCCH) transmission or a physical uplink shared channel (PUSCH) transmission; and
wherein the processor and the memory are further configured to cause the wireless communication device to receive the third control element in one of the following fields of the second DCI:
a field mapped with multiple sounding reference signal resource indicators (SRIs), each SRI indicating resources for a corresponding sounding reference signal (SRS); or
a field mapped with up to two transmit power control (TPC) commands.

6. A wireless communication device comprising:
a processor;
a transceiver coupled to the processor; and
a memory coupled to the processor,
wherein the processor and the memory are configured to cause the wireless communication device to:
transmit, via the transceiver, a first control element that defines transmission configuration indication (TCI) states usable by a scheduled device;
transmit, via the transceiver, a grant of resources for wireless communication;
transmit, via the transceiver, a second control element configured to indicate a unified transmission configuration indication (TCI) state indicating TCI states assigned for use by the scheduled device in a multi-panel configuration;
transmit, via the transceiver, a third control element configured to cause the scheduled device to adopt the multi-panel configuration; and
communicate with the scheduled device over the granted resources according one or more directional beams defined by the multi-panel configuration.

7. The wireless communication device of claim 6, wherein the processor and the memory are further configured to cause the wireless communication device to:
transmit one or more radio resource control (RRC) signals including the first control element;
transmit first downlink control information (DCI) including the second control element, the second control element indicating, to the wireless communication device, a first spatial direction, and a second spatial direction; and
transmit second downlink control information (DCI) that schedules a communication over the granted resources, the second DCI including the third control element.

8. The wireless communication device of claim 7, wherein the processor and the memory are further configured to cause the wireless communication device to include the third control element in one of the following fields of the second DCI:
a frequency division resource allocation (FDRA) field,
a time division research allocation (TDRA) field,
a redundancy version (RV) field, or
a multi-panel reception indication field.

9. The wireless communication device of claim 7, wherein the communication that is scheduled by the second DCI is a physical uplink control channel (PUCCH) transmission or a physical uplink shared channel (PUSCH) transmission to be transmitted to the wireless communication device; and
wherein the processor and the memory are further configured to cause the wireless communication device to include the third control element in one of the following fields of the second DCI:
a field mapped with multiple sounding reference signal resource indicators (SRIs), each SRI indicating resources for a corresponding sounding reference signal (SRS); or
a field mapped with multiple transmit power commands (TPCs).

10. A method of wireless communication operable by a scheduled device having a plurality of antenna elements, the method comprising:
receiving a first control element that defines one or more transmission configuration indication (TCI) states usable by the scheduled device;
receiving a second control element configured to indicate a unified transmission configuration indication (TCI) state indicating TCI states assigned for use by the scheduled entity in a multi-panel configuration of the plurality of antenna elements;
receiving a grant of resources for wireless communication;
receiving a third control element enabling use of the multi-panel configuration; and
communicating over the granted resources utilizing a single-panel configuration of the plurality of antenna elements or the multi-panel configuration of the plurality of antenna elements according to the third control element.

11. The method of claim 10, further comprising:
configuring a first antenna panel corresponding to a first subset of a plurality of antenna elements for directional communication along a first spatial direction indicated by the unified TCI state; and
configuring a second antenna panel corresponding to a second subset of the plurality of antenna elements for directional communication along a second spatial direction indicated by the unified TCI state.

12. The method of claim 11, further comprising:
receiving one or more radio resource control (RRC) signals including the first control element;
receiving first downlink control information (DCI) including at least a part of the second control element, the second control element indicating, to scheduled device, the first spatial direction, and the second spatial direction; and
receiving second downlink control information (DCI) that includes the grant of resources for wireless communication and the third control element.

13. The method of claim 12, further comprising obtaining the third control element from one or more of the following fields of the second DCI:
a frequency division resource allocation (FDRA) field,
a time division research allocation (TDRA) field,
a redundancy version (RV) field, or
a multi-panel indication field.

14. The method of claim 12,
wherein the communication that is scheduled by the second DCI is a physical uplink control channel (PUCCH) transmission or a physical uplink shared channel (PUSCH) transmission; and
wherein the method further comprises:
obtaining the third control element from one of the following fields of the second DCI:
a field mapped at least two sounding reference signal resource indicators (SRIs), each SRI indicating resources for a corresponding sounding reference signal (SRS); or
a field mapped with at least two transmit power commands (TPCs).

15. A method of wireless communication operable by a scheduling device, the method comprising:
transmitting a first control element that defines transmission configuration indication (TCI) states usable by a scheduled device;
transmitting a grant of resources for wireless communication;
transmitting a second control element configured to indicate a unified transmission configuration indication (TCI) state indicating TCI states assigned for use in a multi-panel configuration;
transmitting a third control element configured to cause the scheduled device to adopt the multi-panel configuration; and
communicating with the scheduled device over the granted resources according one or more directional beams defined by the multi-panel configuration.

16. The method of claim 15, further comprising:
transmitting one or more radio resource control (RRC) signals including the first control element;
transmitting first downlink control information (DCI) including the second control element, the second control element indicating, for the scheduled device, a first spatial direction, and a second spatial direction; and
transmitting second downlink control information (DCI) that schedules a communication over the granted resources, the second DCI including the third control element.

17. The method of claim 16, further comprising including the third control element in one of the following fields of the second DCI:
a frequency division resource allocation (FDRA) field,
a time division research allocation (TDRA) field,
a redundancy version (RV) field, or
a multi-panel reception indication field.

18. The method of claim 16,
wherein the communication that is scheduled by the second DCI is a physical uplink control channel (PUCCH) transmission or a physical uplink shared channel (PUSCH) transmission to be transmitted to the scheduling device; and
wherein the method further comprises including the third control element in one of the following fields of the second DCI:
a field mapped with multiple sounding reference signal resource indicators (SRIs), each SRI indicating resources for a corresponding sounding reference signal; or
a field mapped with multiple transmit power commands (TPCs).
